(19) United States
(12) Patent Application Publication
(10) Pub. No.: US 2015/0338943 A1
(43) Pub. Date: Nov. 26, 2015

(54) INTER-DISPLAY COMMUNICATION

(71) Applicant: Microsoft Corporation, Redmond, WA (US)

(72) Inventors: Sean M. Donnelly, Portland, OR (US); Jason D. Wilson, West Linn, OR (US); Ben Clifton, Oregon City, OR (US); John P. Fogarty, West Linn, OR (US)

(73) Assignee: Microsoft Corporation, Redmond, WA (US)

(21) Appl. No.: 14/286,669

(22) Filed: May 23, 2014

(51) Int. Cl. G06F 3/041; H04B 5/00

(52) U.S. Cl. CPC G06F 3/041; H04B 5/0031

(57) ABSTRACT

Embodiments are disclosed that relate to electrostatic communication among displays. For example, one disclosed embodiment provides a multi-touch display comprising a display stack having a display surface and one or more side surfaces bounding the display surface, a touch sensing layer comprising a plurality of transmit electrodes positioned opposite a plurality of receive electrodes, the touch sensing layer spanning the display surface and bending to extend along at least a portion of the one or more side surfaces of the display, and a controller configured to suppress driving the plurality of transmit electrodes of the touch sensing layer for an interval, and during that interval, receive configuration information from a transmit electrode of a touch sensing layer in a side surface of an adjacent display.

### BACKGROUND

Some touch-sensitive displays may recognize gestures that are at least partially performed outside of an area in which graphical content is displayed. For example, aspects of the graphical content may be affected by a gesture that starts and/or ends outside of an active area of the display. To facilitate gesture detection outside of the active area, the touch-sensitive region of the display may be expanded by extending a touch sensor beyond the active area. This expansion, however, constrains the mechanical and industrial design of the display, for example by significantly increasing the size of a bezel and/or cover glass of the display. These issues are exacerbated in arrays of multiple touch-sensitive displays, as the expansion of touch sensing outside of the active display area of the overall array increases the amount by which adjacent individual active display areas are separated by non-active display areas (e.g., bezels).

### SUMMARY

Embodiments are disclosed that relate to electrostatic communication among displays. For example, one disclosed embodiment provides a multi-touch display comprising a display stack having a display surface and one or more side surfaces bounding the display surface, a touch sensing layer comprising a plurality of transmit electrodes positioned opposite a plurality of receive electrodes, the touch sensing layer spanning the display surface and bending to extend along at least a portion of the one or more side surfaces of the display, and a controller configured to suppress driving the plurality of transmit electrodes of the touch sensing layer for an interval, and during that interval, receive configuration information from a transmit electrode of a touch sensing layer in a side surface of an adjacent display.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an example environment in accordance with an implementation of the present disclosure.

FIG. 2 shows an exemplary electrostatic link and configuration of two touch sensors in accordance with an implementation of the present disclosure.

FIG. 3 shows an exemplary touch sensor utilizing a diamond configuration in accordance with an implementation of the present disclosure.

FIG. 4 shows a flowchart illustrating a method for automatically configuring a display array in accordance with an implementation of the present disclosure.

FIGS. 5A-C show various views of a combined touch sensing/display stack in accordance with an implementation of the present disclosure.

FIG. 6 shows a block diagram of a computing device in accordance with an implementation of the present disclosure.

### DETAILED DESCRIPTION

As described above, some touch-sensitive displays may recognize gestures that are at least partially performed outside of an area in which graphical content is displayed, referred to herein as an “active display area”. A gesture that starts and/or ends outside of the active display area may prompt the display of an element of a graphical user interface (GUI), for example. To facilitate gesture detection and general touch sensing outside of the active display area, the touch-sensitive region of the display may be expanded by extending a touch sensor beyond the active display area. Such expansion, however, constrains the mechanical and industrial design of the display, for example by significantly increasing the size of a bezel of the display housing the extended touch sensor. A similarly problematic increase in the size of components may occur in displays that do not include a bezel—for example, the size of a black mask positioned along the border of such a display and configured to reduce the perceptibility of routing, pads, fiducials, etc. may increase as a touch sensor is expanded beyond the active display area. In both cases, the display design is constrained and the material cost of a substrate (e.g., glass) increased due to touch sensor expansion. These issues are exacerbated when attempting to form an array of multiple touch-sensitive displays, as the expansion of the touch sensors in each display increases the amount by which adjacent active display areas are separated by non-active display areas (e.g., bezels), interrupting the visual continuity of the array and degrading the user experience.

Accordingly, implementations are disclosed herein that relate to electrostatic communication among displays. This may allow rapid, ad-hoc formation of a display array and generation of appropriate portions of graphical content for each display. Moreover, data used to calibrate display output in response to touch input for one display in the display array may be communicated to other displays in the array such that accurate touch sensing throughout the entire array may be provided by calibrating a single display.

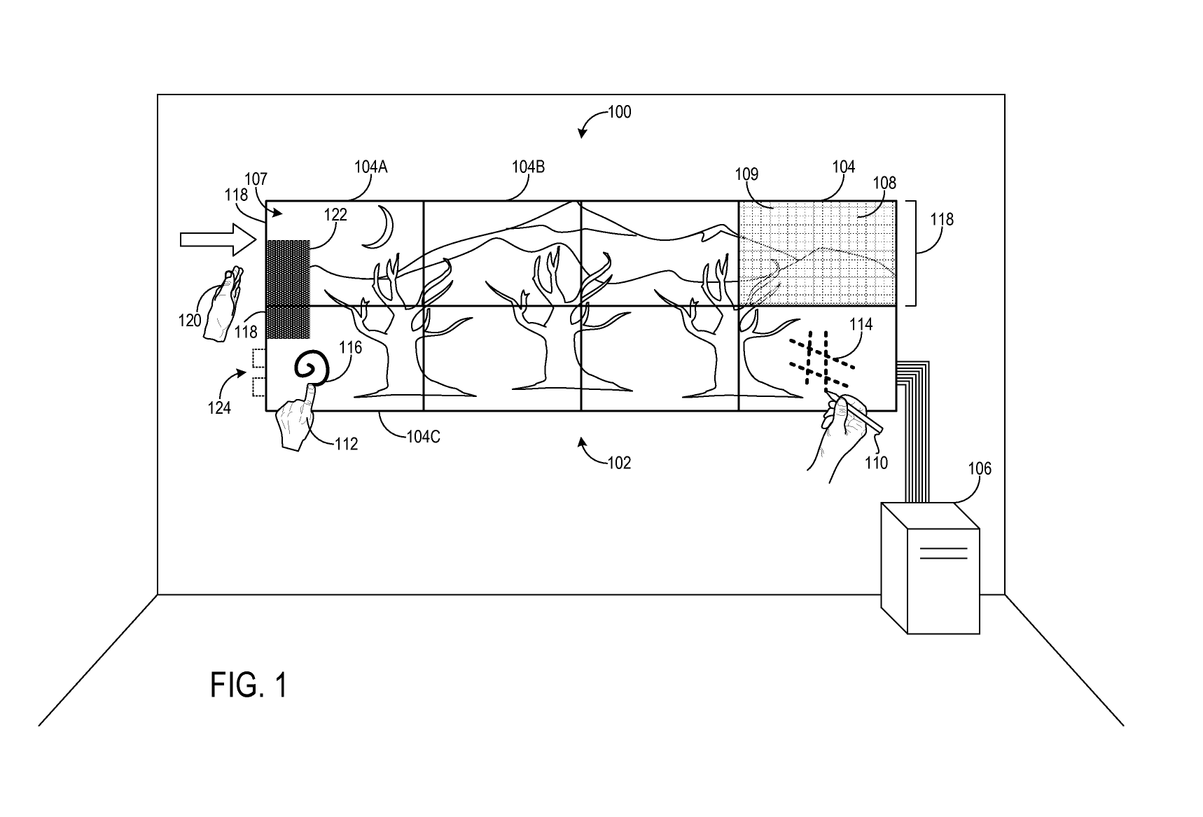

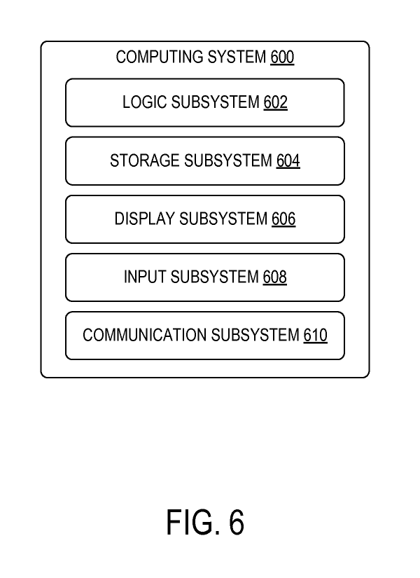

FIG. 1 shows an example environment 100 that includes a display array 102 having a plurality of displays (e.g, display 104) arranged proximate one another in a tiled configuration. As shown, each display 104 is operatively coupled to a display controller 106 configured to determine the arrangement of the displays in display array 102 and send respective portions of graphical content (e.g., video, images, etc.) to each display based on the determined arrangement. In this way, graphical content may be appropriately distributed among displays 104 in display array 102 in order to present large-format video or other imagery that leverages an active display area 107 of the display array. Display controller 106 may include suitable logic and storage subsystems described below with reference to FIG. 6 to carry out the functionality described herein.

Each display 104 may utilize various suitable display technologies to facilitate graphical output, including but not limited to liquid-crystal or organic light-emitting diode display technologies. While each display 104 is shown as being operatively coupled to display controller 106, two or more display controllers may be operatively coupled to the displays, and in some examples, each display may be operatively coupled to a unique display controller. In some implementations, display array 102 may present graphical content that is discontinuous across one or more displays 104, unlike the graphical content shown in FIG. 1. Further, it will be appreciated that the arrangement of display array 102 is provided as an example and is not intended to be limiting in any way—for example, the display array may instead include tiled displays having a combination of landscape and portrait orientations, or bordering displays oriented at oblique angles.

In this example, each display 104 includes a touch sensor (e.g., touch sensor 108, represented in FIG. 1 by shading) spanning its respective display surface (e.g., active display area)—for example, display surface 109. As described in further detail below, each display 104 includes a touch sensing controller (not shown) configured to operate its associated touch sensor 108, and may further communicate configuration information to display controller 106. Touch sensors 108 are configured to detect various types of input. For example, as shown in FIG. 1 touch sensors 108 may be configured to detect input from a stylus 110 and/or human digits 112. Accordingly, the graphical output from displays 104 that receive such input may be modified in response to the reception of the input; shapes 114 and 116 are consequently shown as a result of the input supplied by stylus 110 and human digits 112, respectively. The combination of touch sensing and the tiled configuration of display array 102 in this manner allows the entire active display area of the display array, formed by display surfaces 109 of each display 104, to be used for touch input. It will be appreciated, however, that “touch input” as used herein may refer to near-touch input that does not involve contact with a display surface (e.g., “hover input”), as well as touch input that does involve display surface contact.

Each touch sensor 108 further extends beyond its respective display surface 109 and bends to extend along at least a portion of one or more side surfaces (e.g., side surface 118) that bound the display surface. Side surfaces 118 in this example are substantially perpendicular (e.g., within 5°) to display surface 109, though other angular orientations are possible including those in which a side surface's angular orientation is variable. In the example depicted in FIG. 1, touch sensors 108 specifically extend along portions of all four side surfaces 118 (e.g., top, bottom, left, right). In some implementations, the side surface portions spanned by touch sensors 108 may be the same or unequal for all side surfaces 118, and may further span the entirety of one or more side surfaces. As each display 104 in display array 102 may sense touch input along each side surface 118, touch input may be sensed along the overall perimeter of the display array in addition to at its active display area. As a non-limiting example, FIG. 1 shows input being applied by human digits 120 along portions of side surfaces 118 of the two leftmost displays 104 in display array 102, the human digits particularly moving rightward in FIG. 1 toward the side surfaces. In response, the graphical output of the two leftmost displays 104 is modified by translating a window 122 rightward into view in proportion to the input detected by touch sensors 108 at left side surfaces 118. It will be appreciated, however, that virtually any aspect of a GUI may be modified or controlled based on input supplied at display surfaces 109 and/or side surfaces 118. An operating system (OS) displaying a GUI, for example, may implement policies that control aspects of how the GUI responds to the reception of touch input, such as the distance traversed by window 122 across display array 102 for a distance or velocity of input detected at display surfaces 109 and/or side surfaces 118.

Other actions may be executed in display array 102 in response to detection of touch input along side surfaces 118. For example, virtual buttons 124 may be placed along side surfaces 118 and activated in response to detecting input proximate the virtual buttons via regions of touch sensors 108 positioned along side surfaces 118. Virtual buttons 124 may be operable to control a large range of functions of an underlying GUI and/or OS, including but not limited to adjusting the volume of audio, switching among video sources that provide graphical content to one or more displays 104, etc. Analogous virtual button functionality, and/or general touch sensing functionality, may be provided at the rear surfaces of displays 104 for implementations in which their respective touch sensors extend to the rear surfaces.

Touch sensors 108 may further be used to form electrostatic communication links between adjacent displays 104 to thereby transmit information among the displays. Information transmitted among displays 104 may be used to automatically configure display array 102—that is, determine the number and arrangement (e.g., relative position) of the displays, and communicate this configuration information to display controller 106 so that the display controller may determine the appropriate portions of graphical content to send to each display as described above.

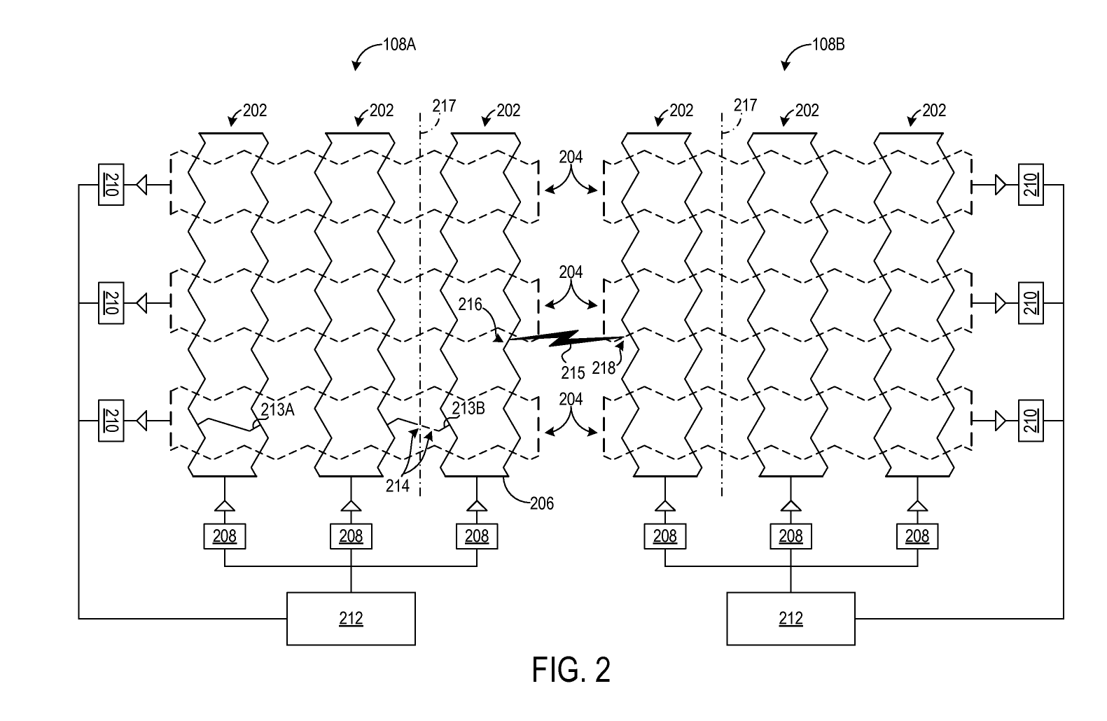

In one implementation, display 104B may receive configuration information from display 104A placed adjacent to and bordering display 104B on a predefined side (e.g., left side) of display 104A. The configuration information may be transmitted between displays 104A and 104B via an electrostatic communication link formed between their respective touch sensors 108. Turning now to FIG. 2, an exemplary electrostatic communication link and the configuration of touch sensors 108A and 108B of displays 104A and 104B, respectively, is shown. FIG. 2 specifically shows a portion of touch sensor 109A along right side surface 118 of display 104A and a portion of touch sensor 108B along left side surface 118 of display 104B, the portions being shown as separated from an otherwise abutted arrangement when mounted in display array 102 for the sake of illustration.

As shown in FIG. 2, touch sensors 108A and 108B both include a plurality of transmit electrodes 202 positioned opposite (e.g., vertically separated from) a plurality of receive electrodes 204, shown in dashed lines in FIG. 2. The plurality of transmit and receive electrodes 202 and 204 electrically terminate at both ends via respective termination pad (e.g., termination pad 206), with the plurality of transmit electrodes being electrically coupled to respective drive circuits 208, and the plurality of receive electrodes being electrically coupled to respective detect circuits 210. The plurality of transmit and receive electrodes 202 and 204 of touch sensors 108A and 108B are operatively coupled to respective touch sensing controllers 212 that may be configured to selectively drive the transmit electrodes and detect resultant voltages and/or currents induced in the receive electrodes. Controllers 212 may interpret deviation of detected voltages and/or currents from expected values as touch input, for example. In some touch sensing modes, one or more of the plurality of transmit electrodes 202 may be sequentially driven (e.g., with a constant or time-varying voltage). For each driven transmit electrode 202, voltage and/or current measurement may be performed for one or more of the plurality of receive electrodes 204. This process is referred to herein as “scanning” a touch sensor, where a “frame” as used herein refers to a completed scan of a desired subset of transmit and receive electrodes 202 and 204. As a non-limiting example, touch sensors 108A and 108B may perform scanning at a rate of 60 Hz.

In the implementation depicted in FIG. 2, the plurality of transmit and receive electrodes 202 and 204 comprise a plurality of alternately, obliquely angled segments that imbue the electrodes with an overall zigzag shape. The oblique positioning of the segments may reduce their perceptibility when looked down upon from a display surface and reduce visual artifacts that may otherwise appear at other orientations, such as aliasing artifacts and moiré patterns. The plurality of transmit electrodes 202 may further include a plurality of intra-column jumpers (e.g., intra-column jumper 213A) spaced throughout each transmit electrode. Intra-column jumpers 213A are electrically conductive structures that bridge adjacent segments in a given transmit electrode 202, and may facilitate the transmission of electrical current throughout the transmit electrode in the presence of electrical discontinuities that otherwise prevent such transmission. In other words, the intra-column jumpers 213A provide alternative routing by which electrical discontinuities may be avoided.

A plurality of inter-column jumpers (e.g., inter-column jumper 213B) may be positioned between adjacent transmit electrodes 202. Unlike intra-column jumpers 213A, inter-column jumpers 213B include a plurality of electrical discontinuities (e.g., discontinuity 214) that render each overall inter-column jumper electrically non-conductive. Being aligned (e.g., horizontally in FIG. 2) with intra-column jumpers 213A, however, inter-column jumpers 213B may reduce the overall visibility of the intra-column jumpers and transmit electrodes 202 by reducing the difference in light output from an underlying display between regions within the transmit electrodes and regions between the transmit electrodes that would otherwise result due to display occlusion by the intra-column jumpers. As seen in FIG. 2, both intra-column jumpers 213A and inter-column jumpers 213B include alternately, obliquely angled segment to reduce visibility. Although not shown, the plurality of receive electrodes 204 may include analogous inter-row and intra-row jumpers. While jumpers 213A and jumpers 213B are depicted in a single location, it will be understood that they may be dispersed throughout the matrix.

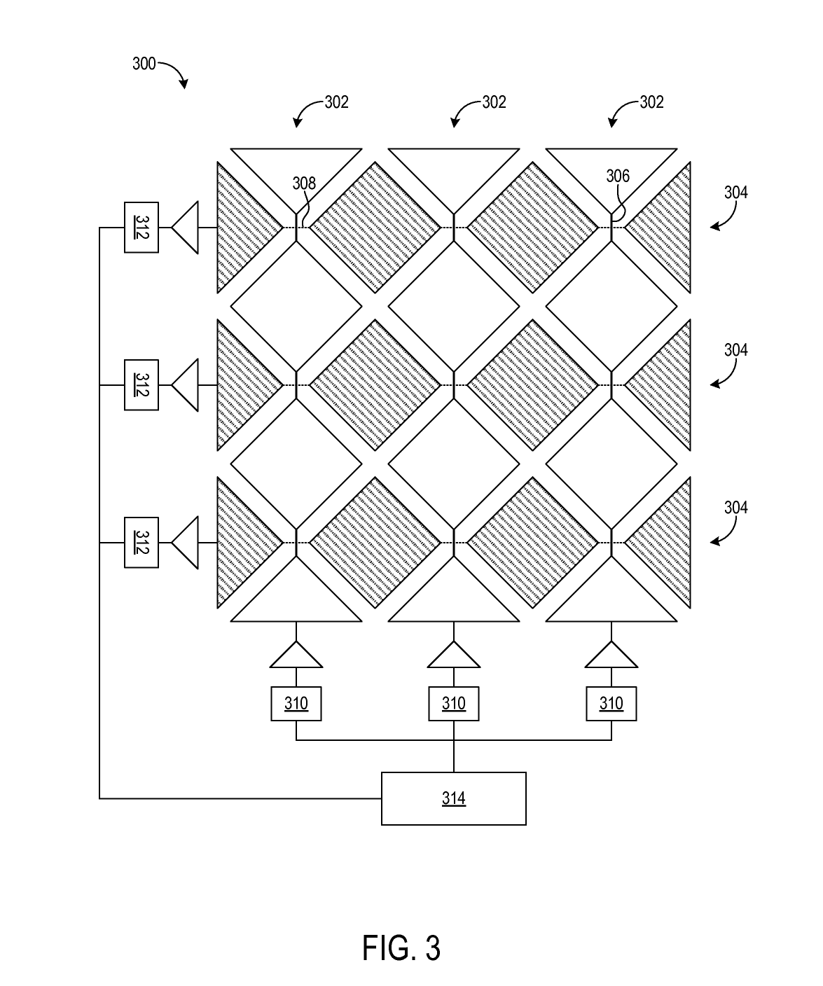

Touch sensor and electrode configurations other than those shown in FIG. 2 are also contemplated. FIG. 3 shows an exemplary touch sensor 300 that utilizes a diamond electrode configuration. In the depicted example, touch sensor 300 comprises a plurality of transmit electrodes 302 and a plurality of receive electrodes 304. Both the plurality of transmit and receive electrodes 302 and 304 assume a quadrilateral geometry (e.g., diamond shape), with the exception of the electrodes that form the perimeter of touch sensor 300, which assume a triangular geometry. The plurality of transmit and receive electrodes 302 and 204 may be comprised of a solid, low opacity material such as indium tin oxide (ITO), while in other examples they may be comprised of a dense metal mesh. Adjacent transmit electrodes 302 are coupled to each other via transmit bridges (e.g., transmit bridge 306), while adjacent receive electrodes 304 are similarly coupled to each other via receive bridges (e.g., receive bridge 308), represented in FIG. 3 via dashed lines. Each of the plurality of transmit electrodes 302 is coupled to a respective drive circuit 310, while each of the plurality of receive electrodes 304 is coupled to a respective detect circuit 312. Drive and detect circuits 310 and 312 are both coupled to a touch sensing controller 314 configured to selectively scan touch sensor 300 and transmit/receive data in the manners described herein. Touch sensor 300 may be included in displays 104 of FIG. 1, for example, and may extend to the side surfaces and optionally further to a rear surface of a device in which it is disposed.

FIG. 2 also shows an electrostatic communication link 215 formed between transmit electrodes 202 of a predefined region 216 of touch sensor 109A of display 104A, and receive electrodes 204 of a predefined region 218 of touch sensor 108B of adjacent display 104B. In this example, although touch sensors 108A and 108B are shown as being separated in FIG. 2 for the sake of clarity, predefined regions 216 and 218 are positioned along corresponding side surfaces 118—particularly, the right side surface and the left side surface of displays 109A and 108B, respectively, which abut each other when placed in display array 102 as seen in FIG. 1. Accordingly, a bend 217 is shown in dashed lines each of the displays 104A, 104B, along which the touch sensors 108A, 108B respectively bend to transition from the planar display surfaces 109A, 109B, to the corresponding side surfaces 118A, 118B. For ease of illustration, a 3×3 matrix of transmit and receive electrodes is depicted; however, it will be appreciate that typically more transmit and receive electrodes are utilized in the matrix. Further, while only one transmit electrode 202 and three receive electrodes 204 are illustrated as positioned along each side surface 118A, 118B, it will be appreciated that more transmit and receive electrodes may be positioned along the side surface. Further, while a single side surface to side surface transfer is shown along side surfaces 118A, 118B, it will be appreciated that each display in the display array may attempt to establish an electrostatic communications link with other displays on each of its four side surfaces.

In some implementations, display 108A may transmit data indicating its presence to display 108B via electrostatic link 215, for example by sending a display identifier, as discussed below. The transmitted data may further indicate a sequence used to scan touch sensor 108A—particularly, a temporal position within the sequence indicating the one or more transmit electrodes 202 being driven may be transmitted to touch sensor 108B, allowing touch sensors 108A and 108B to become synchronized in time. Synchronization between touch sensors 108A and 108B may allow, for a given temporal position in a scanning sequence, controller 212 of touch sensor 108B to suppress driving of the plurality of transmit electrodes 202 for an interval during which configuration information may be received from driven transmit electrodes 202 of touch sensor 108A. In this way, data may be transmitted via electrostatic links established between respective touch sensors of adjacent displays without adversely affecting touch sensing in either display or confounding configuration information by driving transmit electrodes when they should be not be driven.

As described in more detail below, each display 104 in a display array 102 will attempt communication with surrounding displays on each side surface 118 of its perimeter. Accordingly, each display 104 will gather data indicating, for each side surface, a display identifier for the adjacent display on that side surface. Each display may transmit this information to the display controller 106, so that display controller 106 may generate an accurate map of the display array, including the display identifier and position of each display in the array. Using this map, display controller 106 can generate an appropriate display signal for the display array 102.

Inter-display communication in the manner described above may be used to automatically configure a display array such that appropriate portions of graphical content may be sent to each display. Such automatic configuration may be particularly useful, for example, when a display array is permanently installed in a new location, or when a display array is set up on an ad-hoc basis for temporary use, such as at a trade show, exhibition, conference, etc. By such automatic configuration, painstaking programming of the display controller may be omitted, since the displays self-report their relative positions in the array to the display controller.

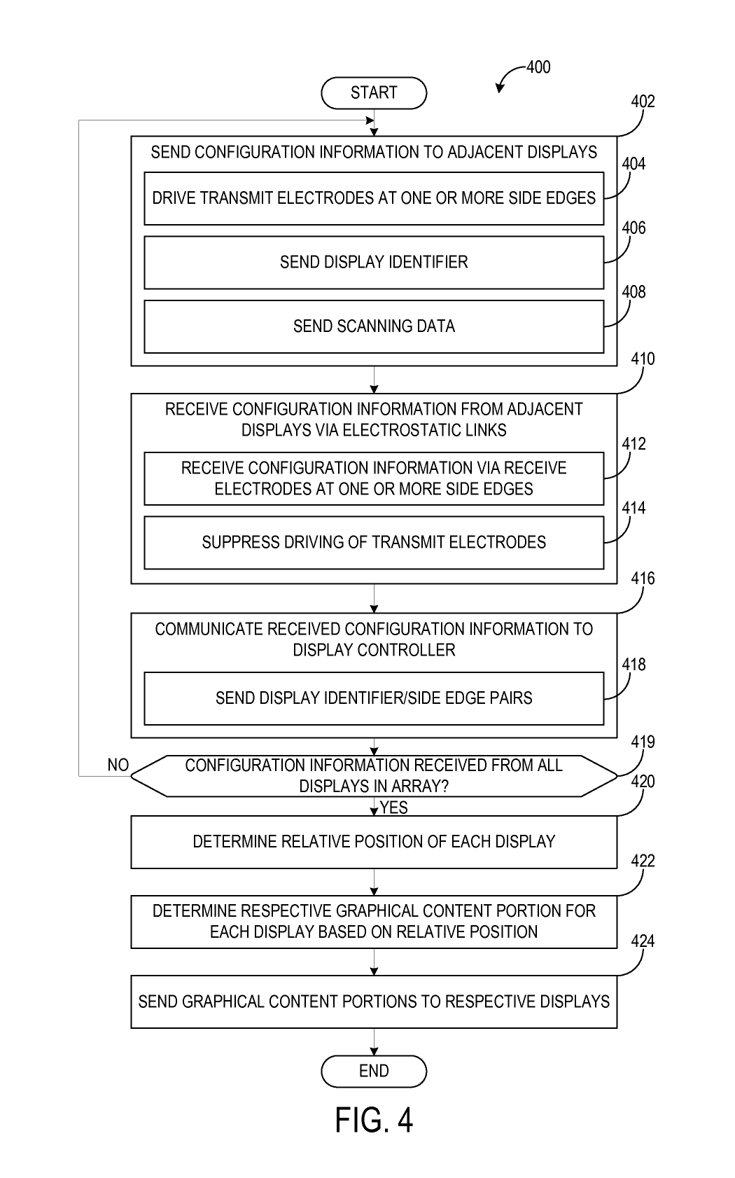

FIG. 4 shows a flowchart illustrating a method 400 for automatically configuring a display array. At 402 of method 400, configuration information is sent from a first display (e.g., display 104A) to adjacent displays (e.g., display 104B) in a display array (e.g., display array 102). Sending the configuration information may include, at 404, driving transmit electrodes (e.g., transmit electrodes 202) at one or more side surfaces (e.g., side surfaces 118) of the first display. In some examples, transmit electrodes at all side surfaces (e.g., left, right, top, bottom) may be driven. Sending the configuration information may further include, at 406, sending a display identifier that uniquely identifies the first display to the adjacent displays. The display identifier may be a predetermined identifier encoded as a binary number and transmitted by driving the transmit electrodes at the one or more side surfaces to thereby create pulses that represent the digits of the binary number, for example. Sending the configuration information may yet further include, at 408, sending scanning data to the adjacent displays. The scanning data may indicate the temporal position of an electrode scanning sequence used to scan receive electrodes (e.g., receive electrodes 204) of the first display, and may allow the adjacent displays to temporally synchronize. For example, a second display (e.g., display 104B) may suppress, via its touch sensing controller, driving of its transmit electrodes for an interval during which configuration information is received from a transmit electrode in a side surface of the adjacent first display, where the interval is determined based on the scanning data received from the first display and particularly the indicated temporal position. By suppression of the transmit electrode during this interval, the receive electrode can more capably receive the transmission from the transmit electrode of the adjacent display.

Further, to enable bi-directional communication between adjacent displays, it will be appreciated that a first interval may be provided during which a first display of an adjacent display pair functions as a receiving display and suppresses the transmit electrodes positioned along the side surface of the display, and a second interval may be provided during which the first display functions as a transmitting display, and the adjacent display in the display pair functions as the receiving display, and thus suppresses its transmission electrode along the side surface of the display, in order to better receive data via the electrostatic link.

Next, at 410 of method 400, configuration information from each of the adjacent displays is received by the first display via electrostatic links formed therebetween. Receiving the configuration information may include, at 412, receiving the configuration information via the receive electrodes of the first display at one or more of the side surfaces. Conversely, configuration information that is not received at one or more side surfaces may be used to determine the relative positioning of a display. Identification of corner displays (e.g., display 104A) in the display array, for example, may be performed by determining that configuration information is not being received at two of the side surfaces (e.g., left and top side surfaces). Receiving the configuration information may also include, at 414, suppressing driving of the transmit electrodes of the first display for an interval so that reception of the configuration information is not confounded. The interval during which transmit electrode driving is suppressed may be determined based on the received configuration information and particularly the scanning data.

Next, at 416 of method 400, the configuration information received at 410 by the first display is communicated to a display controller. The first display may communicate the configuration information to the display controller via a touch sensing controller through a suitable communication interface, for example. Communicating the configuration information may include, at 418, sending display identifiers for each of the adjacent displays in addition to the side surface at which each display identifier was received. Each display identifier and associated side surface at which the identifier was received may be sent to the display controller as a pair. Sending the display identifiers at 418 may also include communicating, from the first display, a display identifier identifying itself (e.g., an identifier identifying the first display). As a non-limiting example, display 104A in display array 102 may communicate to display controller 106 a display identifier identifying display 104A, a display identifier identifying display 104B and data indicating that this display identifier was received at the right side surface 118 of display 104A, and a display identifier identifying a display 104C and data indicating that this display identifier was received at the bottom side surface 118 of display 104A. In this example, display 104A may also send to display controller 106 data indicating that display identifiers were not received at the top or left side surfaces 118.

Continuing with FIG. 4, next, at 419 of method 400, it is determined whether configuration information for all displays in the display array has been received by the display controller. If it is determined that configuration information for all displays in the display array has been received by the display controller (YES), method 400 proceeds to 420. If it is determined that configuration information for all displays in the display array has not been received by the display controller (NO), method 400 returns to 402 where configuration information is sent, received, and communicated for the remaining displays in the display array.

At 420 of method 400, the relative position of each display in the display array is determined by the display controller. The display controller may determine, for a given display, its relative position in the display array by analyzing the display identifiers it received, the side surfaces at which they were received, and any side surfaces at which display identifiers were not received.

Next, at 422 of method 400, a respective portion of graphical content is determined for each display based on their relative positions determined at 420. Determination of the respective graphical content portions may be performed in various suitable manners. In a display array having displays of equal size positioned at the same orientation (e.g., landscape), the graphical content may be divided into equal portions, for example.

Finally, at 424 of method 400, the portions of graphical content are sent to their respective displays.

Method 400 as shown and described may facilitate rapid, ad-hoc formation of a display array and correspondingly rapid distribution of appropriate graphical content to each display in the array. Using method 400, a display array may include a plurality of displays where each display is configured to communicate display identifiers and positions of adjacent displays to a display controller, based on configuration information received from the adjacent displays via corresponding electrostatic links formed between touch sensor regions on a side surface of each display pair. Method 400, however, may be applied to other types of devices having displays, such as portable personal computers, smartphones, tablets, and other movable electronic devices with displays. Thus, displays 103 described above may be displays housed in smartphones, tablets, or laptop computers, for example.

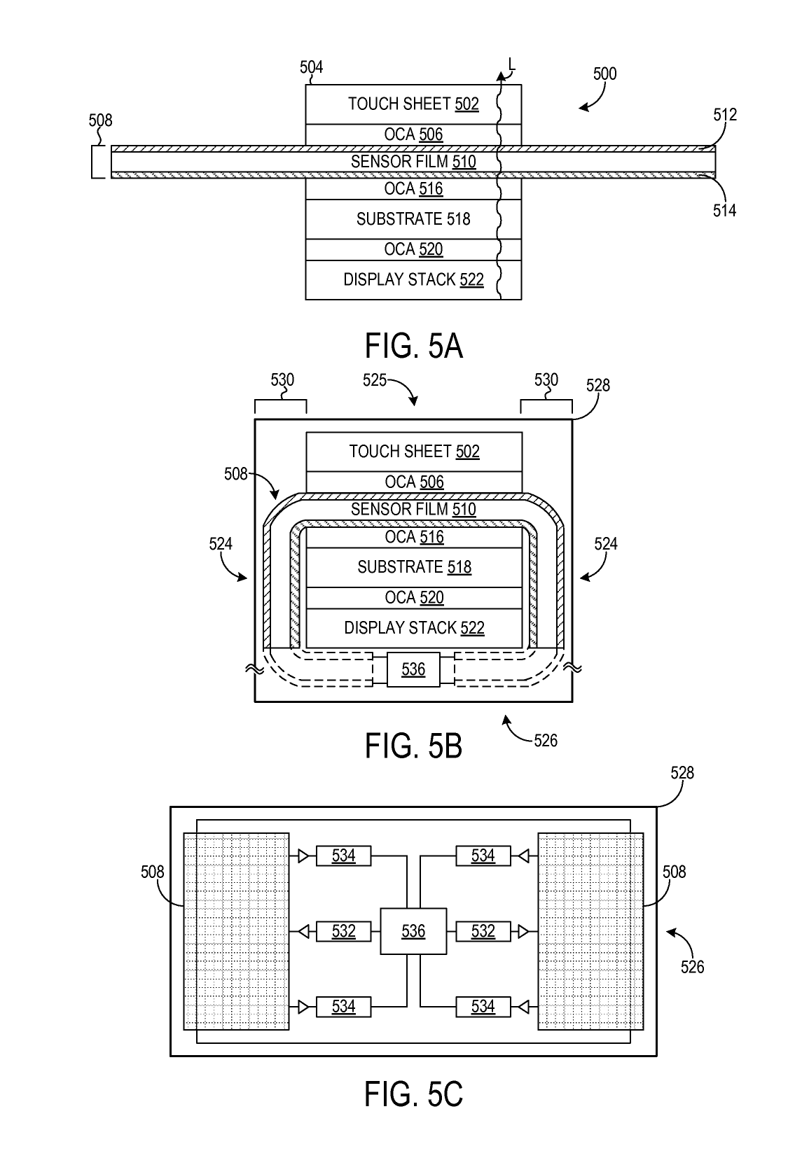

FIG. 5A shows a cross-sectional view of a combined touch sensing/display stack 500. Stack 500 may be used to form a touch-sensitive display capable of detecting touch outside an active display area, particularly along the side surfaces, and optionally the rear surface, of the display. In the depicted implementation, stack 500 includes an optically clear touch sheet 502 having a top surface 504 for receiving touch input (or proximate hover input). Touch sheet 502 may be comprised of various suitable materials, including but not limited to glass or plastic. An optically clear adhesive (OCA) layer 506 bonds a bottom surface of touch sheet 502 to a top surface of a touch sensing layer or touch sensor 508. As used herein, “optically clear adhesive” refers to a class of adhesives that transmit substantially all (e.g., about 99%) of incident visible light.

Touch sensor 508 comprises a sensor film 510, a transmit electrode layer 512 comprising a plurality of transmit electrodes, and a receive electrode layer 514 comprising a plurality of receive electrodes. Film 510 and layers 512 and 514 may be integrally formed as a single layer by depositing layer 512 on a top surface of film 510, and by depositing layer 514 on a bottom surface of the film. In other implementations, layers 512 and 514 may be formed as separate layers and subsequently bonded via an OCA layer.

Transmit and receive electrode layers 512 and 514 may be formed by a variety of suitable processes. Such processes may include deposition of metallic wires onto the surface of an adhesive, dielectric substrate; patterned deposition of a material that selectively catalyzes the subsequent deposition of a metal film (e.g., via plating); photoetching; patterned deposition of a conductive ink (e.g., via inkjet, offset, relief, or intaglio printing); filling grooves in a dielectric substrate with conductive ink; selective optical exposure (e.g., through a mask or via laser writing) of an electrically conductive photoresist followed by chemical development to remove unexposed photoresist; and selective optical exposure of a silver halide emulsion followed by chemical development of the latent image to metallic silver, in turn followed by chemical fixing. In one example, metalized sensor films may be disposed on a user-facing side of a substrate, with the metal facing away from the user or alternatively facing toward the user with a protective sheet (e.g., comprised of polyethylene terephthalate (PET)) between the user and metal. Although TCO is typically not used in the electrodes, partial use of TCO to form a portion of the electrodes with other portions being formed of metal is possible. In one example, the electrodes may be thin metal of substantially constant cross section, and may be sized such that they may not be optically resolved and may thus be unobtrusive as seen from a perspective of a user. Suitable materials from which electrodes may be formed include various suitable metals (e.g., aluminum, copper, nickel, silver, gold, etc.), metallic alloys, conductive allotropes of carbon (e.g., graphite, fullerenes, amorphous carbon, etc.), conductive polymers, and conductive inks (e.g., made conductive via the addition of metal or carbon particles).

The materials that comprise film 510 and layers 512 and 514 may be particularly chosen to allow touch sensor 508 to be bent along at least a portion of the display, and optionally to the rear surface of the display. For example, film 510 may be comprised of cyclic olefin copolymer (COC), polyethylene terephthalate (PET), or polycarbonate (PC).

A second OCA layer 516 bonds the bottom surface of touch sensor 508 to the top surface of a substrate 518, which may be comprised of various suitable materials including but not limited to glass, acrylic, or PC. A third OCA layer 520 bonds the bottom surface of substrate 518 to the top surface of a display stack 522, which may be a liquid crystal display (LCD) stack, organic light-emitting diode (OLED) stack, plasma display panel (PDP), or other flat panel display stack. For implementations in which display stack 522 is an OLED stack, substrate 518 may be omitted, in which case a single OCA layer may be interposed between touch sensor 508 and the display stack. Regardless, display stack 522 is operable to emit visible light L upwards through stack 500 and top surface 504 such that graphical content may be perceived by a user.

FIG. 5B shows stack 500 with touch sensor 508 bent to extend along side surfaces 524 of the stack. In the depicted example, touch sensor 508 extends along the entirety of side surfaces 524. In other implementations, however, touch sensor 508 may extend along a portion of, and not the entirety of, side surfaces 524. In either case, touch sensing along the side surfaces of a display and inter-display communication of configuration information according to the approaches described herein may be facilitated by the bent configuration of touch sensor 508.

As seen in FIG. 5B, touch sensor 508 is imbued with a degree of curvature to facilitate bending and its transition from extending along a display surface 525 (e.g., parallel to touch sheet 502) to extending along side surfaces 524. Touch sensor 508 may be bent with such curvature to avoid sharp angles (e.g., 90°) that may degrade the touch sensor and its constituent layers. Similarly, FIG. 5B shows how touch sensor 508 may be optionally bent in a smooth manner to extend along at least a portion of a rear surface 526 of stack 500, the portion extending along the rear surface shown in dashed lines. In this configuration, touch sensing may be performed along rear surface 526 in addition to inter-display communication for display arrangements in which the rear surfaces of two displays are abutted or placed in proximity to each other. For example, one or more virtual buttons (e.g., virtual buttons 124) may be placed along one or more side surfaces of a display and activated in response to detecting input via touch sensor along the one or more side surfaces. In the depicted example, rear surface 526 is substantially parallel (e.g., within 5°) to display surface 525, though other angular orientations are possible.

FIG. 5B also shows stack 500 and its constituent components positioned inside a housing 528. Housing 528 includes a bezel that bounds the active display area of stack 500 while preventing perception of the components positioned within the housing (e.g., touch sensor 508, display stack 522, etc.). Portions of the bezel that bound the active display area along display surface 525 and at least partially extend along side surfaces 524 are represented at 530. In contrast to other approaches that expand the touch sensing capability of a touch-sensitive display beyond its active display area, the expansion of the bezel, and particularly portions 530, is minimized due to the bending of touch sensor 508. Moreover, while highly sharp bending angles in touch sensor 508 may be avoided, a nevertheless high degree of curvature may be achieved, which may be perceived by users as a 90° angle.

While shown as including a bezel, it will be appreciated that housing 528 may include other components positioned around its perimeter and not a bezel in other implementations. For example, housing 528 may include a black mask positioned along its border and configured to reduce the perceptibility of components in stack 500. The touch sensor configuration shown in FIGS. 5A-C, and methods of operating such described herein, are equally applicable to such displays that lack a bezel.

The bezel, and portions 530, may be used to restrain touch sensor 508 and particularly its bent portions along side surfaces 524 and optionally along rear surface 526 to ensure that desired positioning is maintained. For example, double sided adhesive may be attached to touch sensor 508 at one side and to the bezel at the other side to restrain touch sensor 508. In another example, mechanical clamping may be used. In yet another implementation, the bezel itself, when placed around bent touch sensor 508 may restrain the touch sensor.

FIG. 5C shows a rear view along rear surface 526 of stack 500. As shown, touch sensor 508 extends along a portion of rear surface 526, with the constituent transmit and receive electrodes being coupled to drive circuits 532 and detect circuits 534, respectively, which are both in turn coupled to a touch sensing controller 536. Touch sensing controller 536 may operate drive and detect circuits 532 and 534 in the manners described above to facilitate touch sensing and inter-display communication. The electrodes formed in touch sensor 508 may be arranged in the zigzag formation shown in FIG. 2, the diamond formation shown in FIG. 3, or any other suitable formation. Further, various electrode components may or may not be formed within touch sensor 508—for example, termination pads that electrically terminate the electrodes may or may not be included in touch sensor 508. Other non-electrode components may be formed in touch sensor 508, such as a near-field communication (NFC) antenna, which may be placed in the touch sensor along side surfaces 524 or rear surface 526. Still further, while shown as a unitary, contiguous sheet, touch sensor 508 may be formed as two or more separate sheets. For example, a plurality of touch sensing strips each comprising one or more electrodes may be placed within stack 500 and bent along a portion of side surfaces 524 and optionally rear surface 526.

It will be appreciated that the various views of stack 500 shown in FIG. 5A-C are provided for the sake of illustration and are not intended to be limiting. Particularly, the dimensions of stack 500 and its constituent components are exaggerated for clarity.

In some implementations, the methods and processes described herein may be tied to a computing system of one or more computing devices. In particular, such methods and processes may be implemented as a computer-application program or service, an application-programming interface (API), a library, and/or other computer-program product.

FIG. 6 schematically shows a non-limiting implementation of a computing system 600 that can enact one or more of the methods and processes described above. For example computing system may be used as display controller 106, described above. Computing system 600 is shown in simplified form. Computing system 600 may take the form of one or more personal computers, server computers, tablet computers, home-entertainment computers, network computing devices, gaming devices, mobile computing devices, mobile communication devices (e.g., smart phone), and/or other computing devices.

Computing system 600 includes a logic machine 602 and a storage machine 604. Computing system 600 may optionally include a display subsystem 606, input subsystem 608, communication subsystem 610, and/or other components not shown in FIG. 6.

Logic machine 602 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 604 includes one or more physical devices configured to hold instructions executable by the logic machine to implement the methods and processes described herein. When such methods and processes are implemented, the state of storage machine 604 may be transformed—e.g., to hold different data.

Storage machine 604 may include removable and/or built-in devices. Storage machine 604 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 604 may include volatile, nonvolatile, dynamic, static, read/write, read-only, random-access, sequential-access, location-addressable, file-addressable, and/or content-addressable devices.

It will be appreciated that storage machine 604 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 602 and storage machine 604 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 600 implemented to perform a particular function. In some cases, a module, program, or engine may be instantiated via logic machine 602 executing instructions held by storage machine 604. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 606 may be used to present a visual representation of data held by storage machine 604. This visual representation may take the form of a graphical user interface (GUI). As the herein described methods and processes change the data held by the storage machine, and thus transform the state of the storage machine, the state of display subsystem 606 may likewise be transformed to visually represent changes in the underlying data. Display subsystem 606 may include one or more display devices utilizing virtually any type of technology. Such display devices may be combined with logic machine 602 and/or storage machine 604 in a shared enclosure, or such display devices may be peripheral display devices.

When included, input subsystem 608 may comprise or interface with one or more user-input devices such as a keyboard, mouse, touch screen, or game controller. In some implementations, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 610 may be configured to communicatively couple computing system 600 with one or more other computing devices. Communication subsystem 610 may include wired and/or wireless communication devices compatible with one or more different communication protocols. As non-limiting examples, the communication subsystem may be configured for communication via a wireless telephone network, or a wired or wireless local- or wide-area network. In some implementations, the communication subsystem may allow computing system 600 to send and/or receive messages to and/or from other devices via a network such as the Internet.

It will be understood that the configurations and/or approaches described herein are exemplary in nature, and that these specific implementations or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A multi-touch display, comprising:
a display stack having a display surface and one or more side surfaces bounding the display surface;
a touch sensing layer comprising a plurality of transmit electrodes positioned opposite a plurality of receive electrodes, the touch sensing layer spanning the display surface and bending to extend along at least a portion of the one or more side surfaces of the display; and
a touch sensing controller configured to suppress driving the plurality of transmit electrodes of the touch sensing layer for an interval, and during that interval, receive configuration information from a transmit electrode of a touch sensing layer in a side surface of an adjacent display.

2. The multi-touch display of claim 1, wherein the configuration information includes a display identifier identifying the adjacent display.

3. The multi-touch display of claim 1, wherein the configuration information includes scanning data indicating a temporal position in an electrode scanning sequence, the interval determined based on the temporal position.

4. The multi-touch display of claim 1, wherein the touch sensing layer further extends to at least a portion of a rear surface of the display.

5. The multi-touch display of claim 1, further comprising one or more virtual buttons placed along the one or more side surfaces of the display, the one or more virtual buttons being activated in response to detecting input via the touch sensing layer along the one or more side surfaces.

6. The multi-touch display of claim 1, wherein the configuration information includes a display identifier and an associated side surface pair identifying the adjacent display and a side surface at which the display identifier was received.

7. The multi-touch display of claim 1, wherein the touch sensing layer comprises a transmit electrode layer and a receive electrode layer separate from the transmit electrode layer and bonded to the transmit electrode layer via an optically clear adhesive.

8. The multi-touch display of claim 1, wherein the touch sensing layer comprises a sensor film, a transmit electrode layer deposited on a top surface of the sensor film, and a receive electrode layer deposited on a bottom surface of the sensor film.

9. The multi-touch display of claim 8, wherein the sensor film is comprised of one of cyclic olefin copolymer, polyethylene terephthalate, and polycarbonate.

10. The multi-touch display of claim 1, wherein a bent portion of the touch sensing layer is restrained by one or more of double sided adhesive, mechanical clamping, and a bezel formed by a housing, the touch sensing layer positioned inside the housing.

11. A method of configuring a display array, comprising:
at a first display, receiving configuration information from an adjacent display bordering the first display on a predefined side of the display, the configuration information being received via an electrostatic communication link established between the first display and the adjacent display; and
communicating the configuration information for the predefined side of the adjacent display from the first display to a display controller to enable the display controller to configure the first display and adjacent display in a display array.

12. The method of claim 11, wherein the electrostatic communication link is formed between transmit electrodes at a predefined region of a touch sensor of the first display and receive electrodes of a predefined region of a touch sensor of the adjacent display.

13. The method of claim 11, wherein the respective predefined regions of the touch sensors of the first and adjacent displays are positioned along corresponding side surfaces of the first and adjacent displays.

14. The method of claim 11, wherein respective touch sensors of the first display and the adjacent display are temporally synchronized.

15. The method of claim 11, wherein at a predefined interval in an electrode scanning sequence of respective touch sensors of the first display and the adjacent display, a transmit electrode is driven on the touch sensor of the adjacent display but a transmit electrode is not driven on the touch sensor of the first display, to enable a receive electrode of the touch sensor of the first display to receive the configuration information from the transmit electrode of the adjacent display.

16. The method of claim 11, wherein the configuration information includes a display identifier for the adjacent display and data indicating the predefined side on which the adjacent display is positioned.

17. The method of claim 11, wherein the first display is further configured to communicate a display identifier identifying itself to the display controller.

18. The method of claim 11, wherein the first and adjacent displays are two of a plurality of displays in the display array, each of the plurality of displays being configured to communicate to the display controller a display identifier and side surface pairs identifying adjacent displays and side surfaces at which the display identifiers were received, the display identifier and side surface pairs determined based on configuration information transmitted between display pairs via electrostatic links formed between touch sensor regions along side surfaces of each display pair.

19. A display system, comprising:
a first display configured to communicate data to a second display by an electrostatic link established between a transmit electrode of a touch sensing layer of the first display and a receive electrode of a touch sensing layer of the second display.

20. The display system of claim 19, wherein
the transmit electrode of the touch sensing layer of the first display is positioned along a side surface of the first display; and
the receive electrode of the second display is positioned along a side surface of the second display.
